(19) United States
(12) Patent Application Publication
(10) Pub. No.: US 2021/0160203 A1
(43) Pub. Date: May 27, 2021

(54) SYSTEM FOR DISARMING ENCRYPTED ATTACHMENT FILES OF E-MAIL AND DISARMING METHOD USING SAME

(71) Applicant: SOFTCAMP, Seongnam-si Gyeonggi-do (KR)

(72) Inventors: Hwan-Kuk BAE, Gyeonggi-do (KR); Jeonghyuck KWON, Gyeonggi-do (KR); Ilhan YOON, Gyeonggi-do (KR); Hyunwoo SONG, Gyeonggi-do (KR)

(21) Appl. No.: 17/045,394

(22) PCT Filed: Feb. 15, 2019
(86) PCT No.: PCT/KR2019/001867

§ 371 Date: Oct. 5, 2020

(30) Foreign Application Priority Data
Apr. 5, 2018 (KR) 10-2018-0039987

(51) Int. Cl. H04L 12/58; H04L 29/06

(52) U.S. Cl. CPC H04L 51/08; H04L 63/20; H04L 51/12

(57) ABSTRACT

Provided is a system and method for disarming an encrypted attachment file of an e-mail. The system includes: a disarming server including: a mail processing module configured to process the transmission and reception of mail data; an attachment file processing module configured to determine and classify whether or not an attachment file is present in the mail data, to determine whether or not the attachment file has been encrypted, and to transmit a decryption code query message; a decryption module configured to decrypt an encrypted attachment file based on the decryption code; and a disarming module configured to disarm one or more selected from a mail body file and attachment file of the mail data, to reconstruct disarmed mail data, and to transfer the disarmed mail data to the mail processing module; and a mail checking module installed in a reception terminal to output the disarmed mail data.

### BACKGROUND

The present invention relates to a system for disarming the encrypted attachment file of an e-mail, which enables not only the determination of whether or not an e-mail has been infected with malware and a disarmament function but also the determination of whether or not the encrypted attachment file of the e-mail has been infected and secure disarmament, and also relates to a disarming method using the same.

The development of communication technology including communication network technology, switching technology and transmission technology, high-performance and intelligent computer technology, software technology, and terminal technology has had a great influence on the development of information and communication. Countries around the world recognize that the rise and fall of future information and communication depends on the establishment of high-speed communication networks, and are spurring the establishment of communication networks.

In particular, with the establishment of high-speed communication networks and the popularization of the Internet, the number of Internet users is increasing exponentially. These Internet users collect various types of latest information and also exchange information with each other through Internet access.

Due to the development of such high-speed communication networks and the Internet, users enjoy considerable benefits in the acquisition and distribution of various types of multimedia information such as text information, voice information, and video information. In contrast, the threats of the leakage of the resources and information of internal networks, particularly information leakage attributable to the illegal intrusion of hackers, which is an adverse effect thereof, is increasing day by day.

Therefore, in order to protect resources and important information of internal networks connected to the Internet from hackers and to prevent the leakage and damage of information caused by malicious programs, research into security systems is being actively conducted both at home and abroad. Many commercial products are commercially available on the market.

Meanwhile, there was proposed a disarming system technology (Patent No. 10-0743372; hereinafter referred to as the “conventional technology”) that determined whether or not the body of an e-mail as well as an attachment file had been infected with malware and disarmed the infected data.

By the way, the conventional technology only determines whether or not a body exposed in an e-mail and files executed by a general application (hereinafter referred to as “constituent files) have been infected and disarms the data, but is not equipped with the function of determining whether or not a compressed file, into which corresponding constituent files are compressed, has been infected and disarming the infected compressed file in order to prevent an application from being immediately executed. It is obvious that although the conventional disarming system determines whether or not a compressed file itself has been infected with malware and disarms the infected file in the same manner as it does for a general attachment file, it is not equipped with the function of determining whether or not constituent files compressed into a compressed file have been infected with malware and then disarming the infected files.

Moreover, when an attachment file is a data file encryptable and encrypted for security, such as an Office document file such as a Word R file, an Excel R file, and a PowerPoint R file, a PDF data file or the like, the conventional disarming system is not equipped with procedures for decrypting an encrypted data file or identifying a decryption code such as a password required for decryption. Therefore, in the security field, there are urgent needs for not only a technology for disarming and securing the constituent files of a corresponding attachment file when a compressed file including constituent files infected with malware or an encrypted data file is attached to an e-mail but also a technology for decrypting and then disarming the encrypted attachment file in a disarming system itself.

### SUMMARY OF THE INVENTION

Accordingly, the present invention has been conceived to overcome the above-described problems, and an object of the present invention is to provide a system for disarming the encrypted attachment file of an e-mail, which can determine whether or not an attachment file attached to an e-mail has been infected with malware and whether or not one or more constituent files provided in the attachment file have been infected with malware and can also determine whether or not an encrypted attachment file and one or more constituent files constituting a compressed file have been infected and perform disarmament, and to also provide a disarming method using the same.

In order to accomplish the above object, the present invention provides a system for disarming an encrypted attachment file of an e-mail, the system including:

a disarming server including: a mail processing module configured to process the transmission and reception of mail data; an attachment file processing module configured to determine and classify whether or not an attachment file is present in the mail data received by the mail processing module, to determine whether or not the attachment file has been encrypted, and to transmit a decryption code query message for decryption; a decryption module configured to decrypt an encrypted attachment file based on the identified decryption code; and a disarming module configured to disarm one or more selected from a mail body file and attachment file of the mail data received by the mail processing module, to reconstruct disarmed mail data, and to transfer the reconstructed, disarmed mail data to the mail processing module; and a mail checking module installed in a reception terminal to output the disarmed mail data received from the mail processing module.

In order to accomplish the above object, the present invention provides a method of disarming an encrypted attachment file of an e-mail, the method including:

a first step of receiving, by a mail processing module, mail data from a mail server;

a second step of disarming, by a disarming module, the mail body file of the mail data;

a third step of determining, by an attachment file processing module, whether or not the attachment file of the mail data has been encrypted;

a fourth step of generating, by the attachment file processing module, a query message for the collection of a decryption code for an encrypted attachment file;

a fifth step of generating, by the disarming module, result report data on the results of the disarmament of the mail body file, generating, by the disarming module, a disarmament result page on which the result report data is posted, generating, by the disarming module, first mail data including the disarmed mail body file, the web address of the disarmament result page and the query message, and transmitting, by the mail processing module, the first mail data;

a sixth step of decrypting, by a decryption module, the encrypted attachment file based on a decryption code entered by a recipient, and decrypting and then disarming, by the disarming module, the attachment file; and

a seventh step of generating, by the disarming module, second mail data including the disarmed attachment file, and transmitting, by the mail processing module, the second mail data.

The present invention has the effects of being capable of determining whether or not an attachment file attached to an e-mail has been infected with malware and whether or not one or more constituent files provided in the attachment file have been infected with malware and also being capable of determining whether or not an encrypted attachment file and one or more constituent files constituting a compressed file have been infected and performing disarmament.

### BRIEF DESCRIPTION OF DRAWINGS

FIG. 1 is a diagram schematically showing the configuration of an e-mail network in which a disarming system according to the present invention is constructed;

FIG. 2 is a block diagram showing the configuration of the disarming system according to the present invention;

FIG. 3 is a flowchart showing a first embodiment of a disarming method based on the disarming system according to the present invention;

FIG. 4 is an image showing the content of the body of a received mail disarmed by the first embodiment of the disarming method according to the present invention;

FIGS. 5 and 6 are images showing disarmament result reports according to the first embodiment;

FIG. 7 is a flowchart showing a second embodiment of a disarming method based on the disarming system according to the present invention;

FIG. 8 is an image showing the content of the body of a received mail disarmed by the second embodiment of the disarming method according to the present invention; and

FIGS. 9 and 10 are images showing disarmament result reports according to the second embodiment.

### DETAILED DESCRIPTION OF THE INVENTION

The features and effects of the present invention described above will become apparent through the following detailed description given in conjunction with the accompanying drawings. Accordingly, those of ordinary skill in the art to which the present invention pertains can easily practice the technical spirit of the present invention. The present invention may be modified in various ways and may have various forms. Specific embodiments will be illustrated in the drawings and described in detail in the following description. However, this is not intended to limit the present invention to the specific embodiments, but should be understood as encompassing all changes, equivalents, and substitutes included in the spirit and technical scope of the present invention. The terms used herein are only used to describe the specific embodiments, and are not intended to limit the present invention.

The term “mail” described in the following detailed description and claims refers to an “e-mail,” which is a mail that is transmitted and received online. Accordingly, the term “mail” should be understood as an e-mail that is transmitted and received online by a transmitter and a recipient.

The “decryption code” is a type of password used to decrypt an encrypted attachment file. In addition, it may be an authentication code or identification information identified through an identity verification procedure.

Specific details of the present invention will be described in detail below with reference to the accompanying drawings.

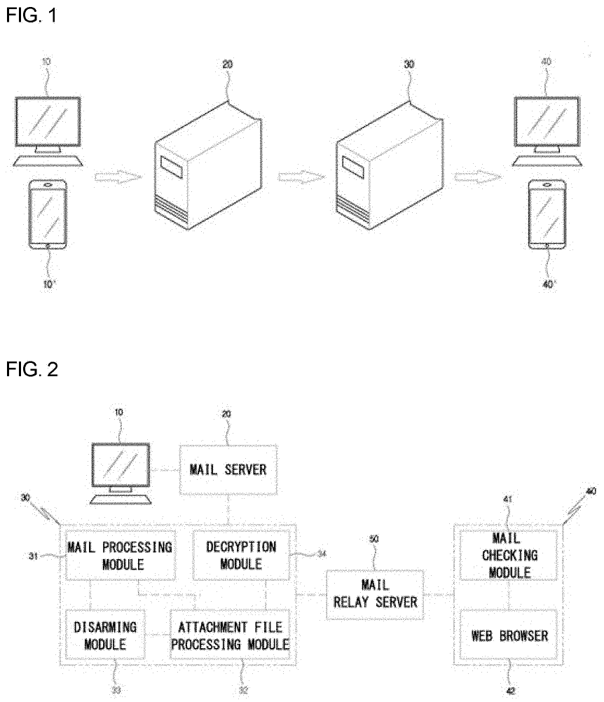

FIG. 1 is a diagram schematically showing the configuration of an e-mail network in which a disarming system according to the present invention is constructed, and FIG. 2 is a block diagram showing the configuration of the disarming system according to the present invention.

The disarming system of the present embodiment includes: a disarming server 30 configured to receive and disarm mail data received from a mail server 20; and a mail checking module 41 installed in a reception terminal 40 or 40′ to output the mail data received from the disarming server 30.

The online transmission and reception of mails are performed via transmission terminals 10 and 10′ (hereinafter referred to as “10”) and reception terminals 40 and 40′ such as general computers 10 and 40 and mobile devices 10′ an 40′ capable of online communication. The mail data communication between the transmission terminal 10 and the reception terminal 40 is performed via a general mail service server 20 (hereinafter referred to as the “mail server”).

Since the specific configurations of the transmission terminal 10, the reception terminal 40 and the mail server 20 for mail communication, and mail communication protocols and processes therebetween are well-known technologies, descriptions thereof will be omitted below.

The disarming server 30 of the present embodiment is a type of e-mail security server that checks and quarantines mail communication between the mail server 20 and the reception terminal 40. The disarming server 30 includes: a mail processing module 31 configured to process the transmission and reception of mail data; an attachment file processing module 32 configured to checks and classifies whether or not an attached file is present in the mail data received by the mail processing module 31, checks whether the attached file has been encrypted, and transmits a decryption code query message for decryption; a decryption module 34 configured to decrypt the encrypted attachment file based on an acquired decryption code; and a disarming module 33 configured to disarm one or more selected from the mail body file and attachment file of the mail data received by the mail processing module 31, to reconstruct disarmed mail data, and to transfer the disarmed mail data to the mail processing module.

The individual components of the disarming server 30 will be described in greater detail below.

The mail processing module 31 first receives mail data, transmitted to a recipient, from the mail server 20, and transmits mail data, generated after disarmament, to the reception terminal 40 of the recipient. Generally, the mail processing module 31 configures an SMTP protocol for the transmission of mail data. The mail processing module 31 is a general mail transmission means that is provided not only in the security server 30 of the present embodiment but also in the mail server 20, a mail relay server, etc. and has the function of transmitting and receiving mails.

For reference, the mail processing module 31 of the present embodiment may communicate with the reception terminal 40 via the mail relay server 50 having a POPS protocol configuration, but is not limited thereto.

The attachment file processing module 32 checks whether or not an attachment file is present in mail data received by the mail processing module 31, whether or not the corresponding attachment file has been encrypted, and whether or not the corresponding attachment file is a compressed file. Furthermore, when it is determined that an encrypted attachment file is present, a subsequent process is performed via the decryption module 34 in order to decrypt the encrypted attachment file. When it is determined that the attachment file is a general compressed file or an encryption compressed file, a subsequent process for decompression is performed.

For reference, the compressed file is obtained by converting one or more constituent files into a file having an extension such as *.zip, *.apk, *.rar, *.7z, *.tar, or the like by compressing the constituent files. The attachment file processing module 32 determines whether or not a compressed file is present by searching for a file having one of the corresponding formats in the attachment file within the mail data.

When it is determined that an encrypted attachment file is present, the attachment file processing module 32 generates a query message in order to collect a decryption code such as a password for decryption processing, and performs processing so that the query message is transmitted via the mail processing module 31. A specific description thereof will be given in detail in conjunction with a disarming method according to the present invention.

Furthermore, when a compressed file is identified, the attachment file processing module 32 decompresses the corresponding compressed file. Meanwhile, the encrypted attachment file identified in the process of checking for an attachment file may be a compressed file. In this case, the attachment file processing module 32 generates a query message for decompression. When the compressed file is not an encrypted, compressed file, the attachment file processing module 32 decompresses the corresponding compressed file into one or more constituent files.

The disarming module 33 disarms one or more selected from the mail body file of mail data received by the mail processing module 31, an attachment file itself attached regardless of whether or not it has been encrypted, and constituent files obtained after decompression when the attachment file is a compressed file, reconstructs disarmed mail body file, attachment file and constituent files as mail data, and transfers the mail data to the mail processing module 31.

The disarmament method of the disarming module 33 may be various, and embodiments thereof are as follows:

In an example of the disarmament method, to enable the disarmament of a disarmament target file regardless of the configuration of malware data for a check for the presence of malware, the disarming module 33 disarms malware not to be activated by converting the format of the disarmament target file one or more times. In other words, the malware present in the disarmament target file is prevented from being activated by converting the extension and data format of the disarmament target file one or more times and then restoring the converted extension and data format into an original extension and original data format.

In another example of the disarmament method, malware data is separately stored, updated and managed, whether the constituent data of a disarmament target file is identical or similar to the managed malware data is determined through the analysis of the constituent data of the disarmament target file, and the disarmament target file is classified as being infected when the data determined to be identical or similar is present in the disarmament target file. The malware present in the disarmament target file classified as described above is prevented from being activated by removing or neutralizing the corresponding data.

In addition, the disarmament method of the disarming module 33 may be various, and may be modified in various manners without departing from the following scope of rights.

Meanwhile, the disarming module 33 generates and manages result report data on the results of the disarmament of the mail data. Furthermore, the disarming module 33 reconstructs disarmed mail data and transmits the reconstructed data to the reception terminal 40 of the recipient through the mail processing module 31. It is obvious that the recipient may check the mail data received by him or her and securely execute a file attached to the mail data by executing the mail checking module 41 installed in the reception terminal 40.

Furthermore, the disarming module 33 posts the result report data on a disarmament result page provided on the website of the disarming server 30 so that the recipient can check the disarmament results and its content in detail. Moreover, the disarming module 33 posts a URL, i.e., the web address of the disarmament result page, on the body content of the mail data transmitted through the disarmament processing module 31. It is obvious that the recipient having received the mail data may access the disarmament result page through the web address posted on the mail body and check for information about the disarmament of the attachment file of the received mail data. Additionally, the mail body file, the compressed file and the constituent files may be downloaded directly from the disarmament result page, which is the website operated by the disarming server 30.

The decryption module 34 decrypts the encrypted attachment file based on the identified decryption code. The decryption code is identified in such a manner that the recipient enters a decryption code in response to the query message of the attachment file processing module 32, the decryption module 34 having received the decryption code decrypts the corresponding encrypted attachment file, and the disarming module 33 may determine whether or not data has been infected with malware and enable disarmament processing by checking the body data of the attachment file.

The decryption module 34 may include not only a decryption function but also an encryption function. The encryption of the decryption module 34 is intended to encrypt the disarmed attachment file like the attachment file of the original mail data and transmit the encrypted, disarmed attachment file when the mail data is reproduced.

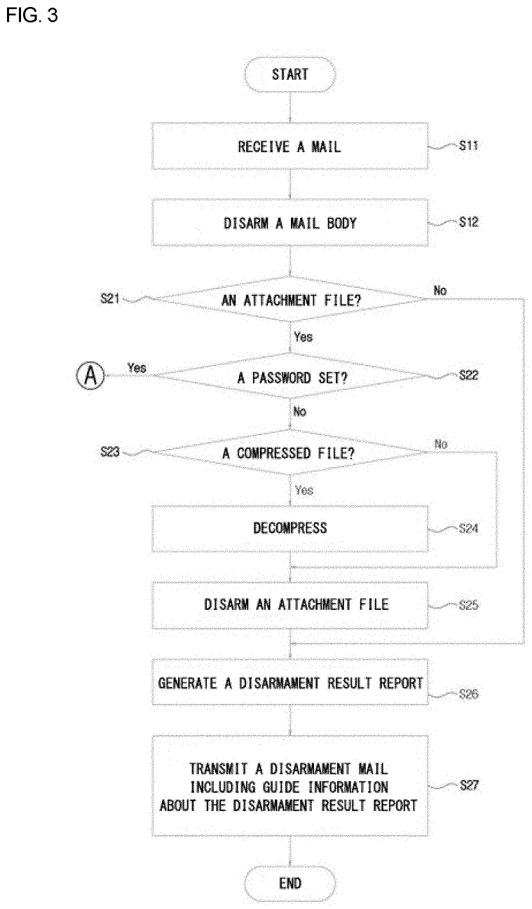

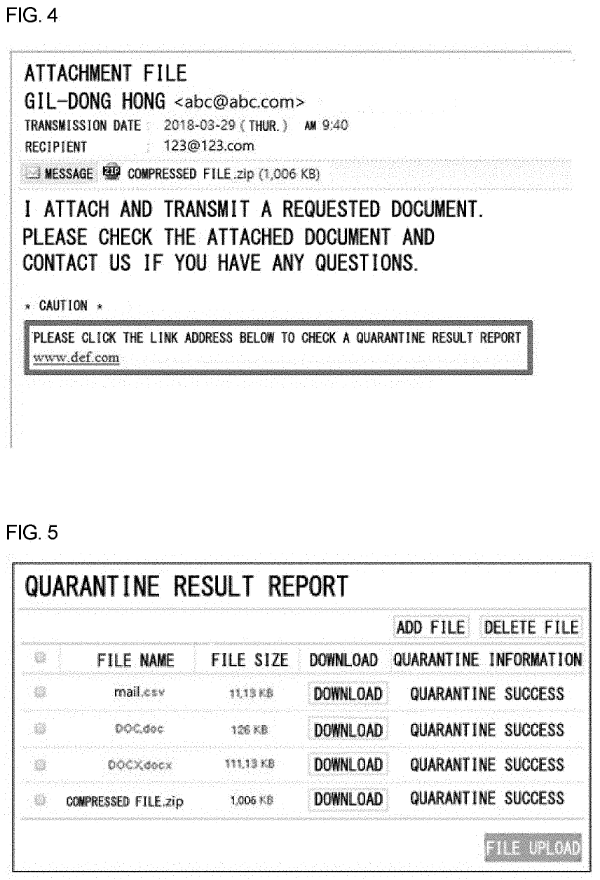

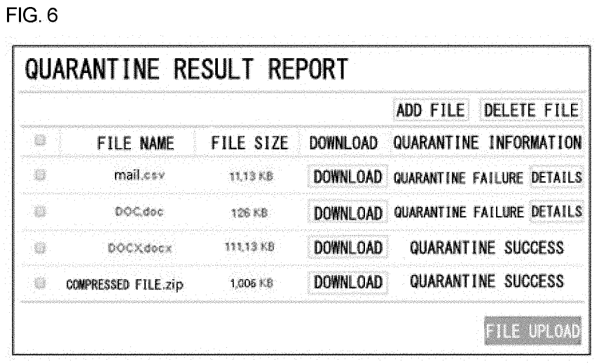

FIG. 3 is a flowchart showing a first embodiment of a disarming method based on the disarming system according to the present invention, FIG. 4 is an image showing the content of the body of a received mail disarmed by the first embodiment of the disarming method according to the present invention, and FIGS. 5 and 6 are images showing disarmament result reports according to the first embodiment.

A disarming method based on the above-described disarming system of the present embodiment will be described in sequence:

S11: Mail reception step

Mail data transmitted through the website, mail program or the like of the transmission terminal 10 is received by the mail processing module 31 of the disarming server 30 through the mail server 20.

The disarming server 30 of the present embodiment may hook mail data, to be received by the reception terminal 40 of a corresponding recipient, in advance when the disarming server 30 is given mail disarmament authority by the recipient.

In addition, the disarming server 30 may preferentially receive mail data received from the outside according to a mail reception network system in which the reception terminal 40 is present, and may disarm the mail data.

S12: Mail body disarmament step

The mail processing module 31 transfers the mail data to the disarming module 33, and the disarming module 33 checks and disarms a mail body file included in the mail data.

In general, the mail body file may be a data file in which text, an image, a table, a link web address, and/or the like entered by a transmitter are included in a basic frame provided by the mail server 20 or a mail program. The disarming module 33 may search for malware in the mail body file and disarm the malware, or may disarm malware through the conversion of an extension.

S21 to S23: Attachment file checking step

Meanwhile, the mail processing module 31 or disarming module 33 transfers the mail data to the attachment file processing module 32, and the attachment file processing module 32 checks whether or not an attachment file is present in the mail data, whether or not a compressed file has been encrypted, and whether or not the attachment file has been compressed.

First, the attachment file processing module 32 determines whether or not an attachment file is present. When it is determined that an attachment file is present, the attachment file processing module 32 determines whether or not an encrypted attachment file is present in the attachment file and whether or not the attachment file has been compressed.

It is obvious when it is determined that an attachment file is not present, the generation of a disarmament result report, which will be described later, is performed immediately.

Furthermore, when it is determined that the compressed file has not been encrypted, the compressed file is decompressed, corresponding constituent files are disarmed, and then a disarmament result report is generated.

S24: Decompression step

When it is determined that the attachment file identified by the attachment file processing module 32 is a non-encrypted, compressed file, the corresponding compressed file is decompressed and one or more constituent files are checked.

The compressed file is a data file in a single file format that is formed by compressing one or more constituent files via a dedicated compression program, and encryption for decompression may be set for such a compressed file.

S25: Attachment file disarmament step

The disarming module 33 checks the constituent files collected when the attachment file processing module 32 decompresses the compressed file, and disarms the constituent file. It is obvious that when the attachment file is not a compressed file, the corresponding attachment file is disarmed.

Since the disarming method has been described above, a description thereof will be omitted below.

The disarmed constituent files, i.e., the attachment file, may be attached to the mail data in a state of being decompressed by the disarming module 33. However, the attachment file processing module 32 may recompress the disarmed attachment file into a compressed file, like the original mail data, and may attach the recompressed, disarmed attachment file to the mail data as an attachment file.

S26: Disarmament result report generation step

The disarming module 33 generates the results of the disarmament of the mail body file, the compressed file and the constituent files as disarmament result data.

Furthermore, a disarmament result page on which the disarmament result data will be posted is generated, and the web address of the disarmament result page is set.

Furthermore, the disarming module 33 performs processing so that the web address is posted on the mail body, and may add guide information about the web address, as shown in FIG. 4, when required.

S27: Disarmed mail transmission

The disarming module 33 reconstructs disarmed mail data, and transmits the reconstructed, disarmed mail data to the mail checking module 41 of the corresponding reception terminal 40 through the mail processing module 31, and the recipient receives and executes the mail data using the mail checking module 41. The mail data executed as described above is output, as shown in FIG. 4, and the recipient determines whether or not a mail body and an attachment file are present, as in the original mail data.

Furthermore, the recipient clicks the web address according to the guide information posted on the mail body in order to check the results of the disarmament of the mail body and the attachment file, checked once by him or her, in greater detail. A web browser 42 provided in the reception terminal 40 accesses and outputs the disarmament result page which is a webpage corresponding to the web address. The recipient checks the disarmament result report posted on the disarmament result page, as shown in FIGS. 5 and 6, by checking the disarmament result page output as described above.

In the present embodiment, the disarmament result report contains the details of the disarmament of the corresponding constituent files in the case of the mail body file, the attachment file itself and the compressed file. When required, the attachment file and the constituent files may be downloaded directly from the corresponding disarmament result page.

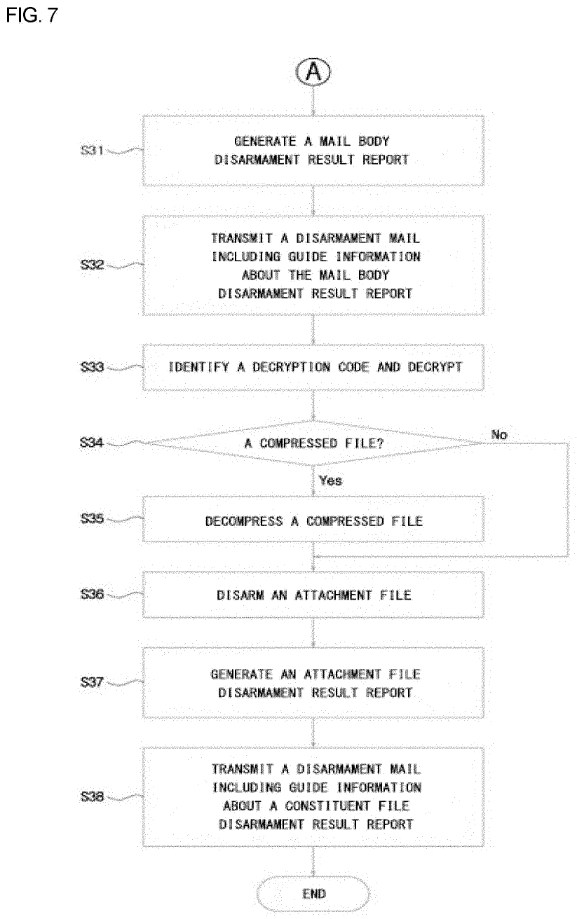

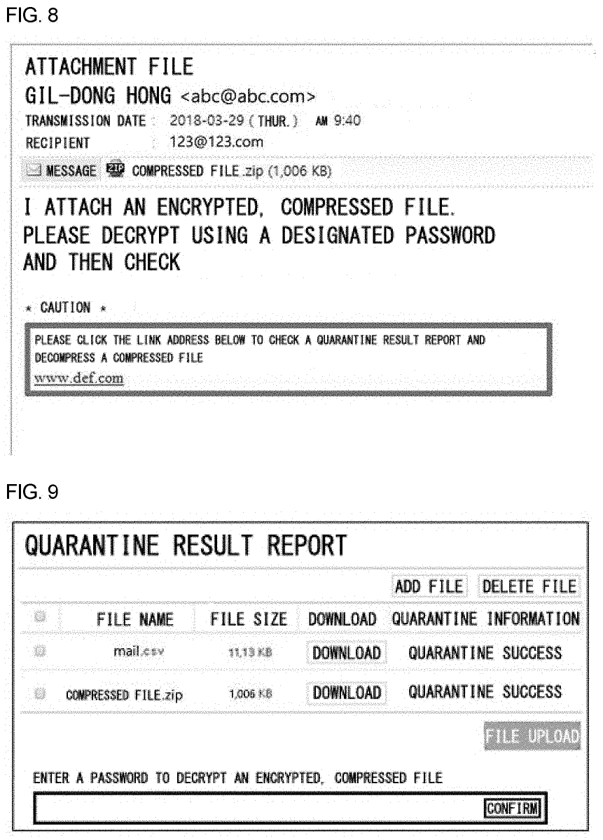

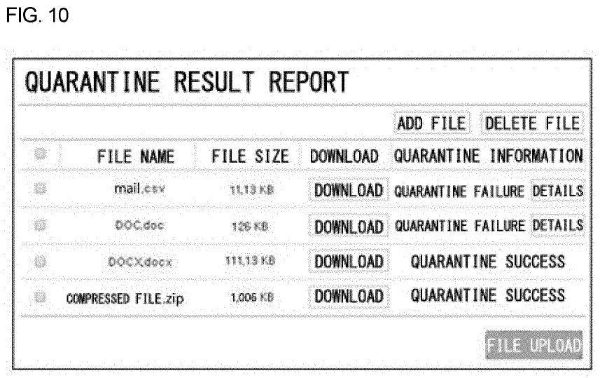

FIG. 7 is a flowchart showing a second embodiment of a disarming method based on the disarming system according to the present invention, FIG. 8 is an image showing the content of the body of a received mail disarmed by the second embodiment of the disarming method according to the present invention, and FIGS. 9 and 10 are images showing disarmament result reports according to the second embodiment.

S31: Disarmament result report generation step

When it is determined at step “S23” that the attachment file has been encrypted, the disarming module 33 first generates the results of the disarmament of the mail body file as disarmament result data.

Furthermore, a disarmament result page on which data on the results of the disarmament of the mail body file will be posted is generated, and the web address of the disarmament result page is set.

Furthermore, the disarming module 33 performs processing so that the web address is posted on the mail body, and adds a decryption code query message for the decryption of an encrypted attachment file. The query message includes content requesting a decryption code for the decryption of the encrypted attachment file from the recipient, and a representation method therefor may be various.

S32: Disarmed mail transmission

The disarming module 33 transmits the mail data, reconstructed after the disarmament of the mail body file has been completed, to the mail checking module 41 of the corresponding reception terminal 40 through the mail processing module 31, and the recipient receives and executes the mail data using the mail checking module 41. The mail data executed as described above is output, as shown in FIG. 8, and the recipient determines whether a mail body and an attachment file are present.

In addition, the recipient checks the results of the disarmament of the mail body and the attachment file, checked by him or her once, in greater detail. Furthermore, in order to enter a decryption code for the decryption of the attachment file in response to the query message, the recipient clicks the web address according to the guide information posted on the mail body. The web browser 42 provided in the reception terminal 40 accesses and outputs a disarmament result page, which is a webpage corresponding to the web address. The recipient checks the disarmament result report posted on the disarmament result page, as shown in FIGS. 9 and 10.

In the present embodiment, the disarmament result report contains the details of the disarmament of the mail body file and the encrypted attachment file itself. When required, the encrypted attachment file may be downloaded directly from the corresponding disarmament result page.

Meanwhile, the disarmament result report is further provided with an entry box for the entry of the decryption code.

S33: Decryption code identification and decryption step

The decryption module 34 checks the mail data, which is the target of the disarmament result page, and checks an encrypted attachment file included in the mail data. Furthermore, the decryption module 34 identifies a decryption code, entered by the recipient, in the disarmament result page.

The encrypted attachment file identified as described above is decrypted using the decryption code, so that the attachment file can be executed.

S34: Step of checking whether or not a compressed file is present

The attachment file processing module 32 determines whether the decrypted attachment file is a compressed file, and prepares a subsequent process for decompression when it is determined that the decrypted attachment file is a compressed file.

S35: Compressed file decompressing step

The attachment file processing module 32 decompresses the compressed file, which is a corresponding decrypted attachment file, and checks corresponding constituent files.

S36: Attachment file disarmament step

The disarming module 33 disarms the constituent files, i.e., the attachment file. Since the method of disarming the attachment file has been described above, a description thereof will be omitted below.

S37: Attachment file disarmament result report generation step

The disarming module 33 generates the results of the disarmament of the attachment file as disarmament result data.

Furthermore, a disarmament result page on which data on the results of the disarmament of the attachment file will be posted is generated, and the web address of the disarmament result page is set. In the present embodiment, the disarmament result page may be the previously generated disarmament result page including the mail body file and the attachment file, and the results of the disarmament of the constituent files are added to the disarmament result report posted on the disarmament result page, as shown in FIGS. 9 and 10. It is obvious that the disarmament result pages have the same web address.

Alternatively, separately from the already generated disarmament result page, disarmament result data on the results of the disarmament of only the constituent files of the compressed file may be generated, and a new disarmament result page on which the corresponding disarmament result data will be posted may be generated.

S38: Disarmed mail transmission step

The disarming module 33 generates a disarmed mail on which the web address of the disarmament result page is posted and to which the disarmed constituent files are attached, and transmits the disarmed mail to the mail checking module 41 of the corresponding reception terminal 40 through the mail processing module 31.

The recipient checks the disarmed mail additionally received from the disarming server 30, checks the results of the disarmament of the constituent files of the encrypted attachment file in a compressed file format, and downloads and executes the disarmed constituent files.

For reference, although the disarming module 33 may generate a disarmed mail by attaching the disarmed constituent files without separate compression, the attachment file processing module 32 may compress and encrypt the constituent files and attach the constituent files to the disarmed mail.

While the above-described detailed description of the present invention has been given with reference to the preferred embodiments of the present invention, it will be understood by those skilled in the art or those having ordinary knowledge in the art that the present invention may be modified and altered in various manners without departing from the technical scope and spirit of the present invention that are described in the attached claims.

1. A system for disarming an encrypted attachment file of an e-mail, the system comprising:
a disarming server including: a mail processing module configured to process transmission and reception of mail data; an attachment file processing module configured to determine and classify whether or not an attachment file is present in the mail data received by the mail processing module, to determine whether or not the attachment file has been encrypted, and to transmit a decryption code query message for decryption; a decryption module configured to decrypt an encrypted attachment file based on the identified decryption code; and a disarming module configured to disarm one or more selected from a mail body file and attachment file of the mail data received by the mail processing module, to reconstruct disarmed mail data, and to transfer the reconstructed, disarmed mail data to the mail processing module; and
a mail checking module installed in a reception terminal to output the disarmed mail data received from the mail processing module.

2. The system of claim 1, wherein the disarming module generates and manages result report data on results of the disarmament of the mail data.

3. The system of claim 1, wherein:
the disarming module generates and manages result report data on results of the disarmament of the mail data, generates a disarmament result page on which the result report data is posted, and posts a web address of the disarmament result page on the disarmed mail data; and
the attachment file processing module identifies the decryption code by posting the query message on the disarmament result page.

4. The system of claim 1, wherein:
the attachment file is a compressed file in which one or more constituent files are compressed into a single data file; and
the attachment file processing module decompresses and compresses the compressed file.

5. The system of claim 4, wherein the attachment file processing module generates a disarmed compressed file by compressing the disarmed constituent files of the compressed file, and attaches the disarmed compressed file to the disarmed mail data.

6. The system of claim 1, wherein the disarming module additionally generates and transmits mail data including a disarmed attachment file.

7. A method of disarming an encrypted attachment file of an e-mail, the method comprising:
a first step of receiving, by a mail processing module, mail data from a mail server;
a second step of disarming, by a disarming module, a mail body file of the mail data;
a third step of determining, by an attachment file processing module, whether or not an attachment file of the mail data has been encrypted;
a fourth step of generating, by the attachment file processing module, a query message for collection of a decryption code for an encrypted attachment file;
a fifth step of generating, by the disarming module, result report data on results of the disarmament of the mail body file, generating, by the disarming module, a disarmament result page on which the result report data is posted, generating, by the disarming module, first mail data including the disarmed mail body file, a web address of the disarmament result page and the query message, and transmitting, by the mail processing module, the first mail data;
a sixth step of decrypting, by a decryption module, the encrypted attachment file based on a decryption code entered by a recipient, and decrypting and then disarming, by the disarming module, the attachment file; and
a seventh step of generating, by the disarming module, second mail data including the disarmed attachment file, and transmitting, by the mail processing module, the second mail data.

8. The method of claim 7, wherein:
the attachment file is a compressed file in which one or more constituent files are compressed into a single data file; and
the sixth step further comprises: decompressing, by the attachment file processing module, the decrypted, compressed file into constituent files; and disarming, by the disarming module, the constituent files.

9. The system of claim 2, wherein the disarming module additionally generates and transmits mail data including a disarmed attachment file.

10. The system of claim 3, wherein the disarming module additionally generates and transmits mail data including a disarmed attachment file.
